(19) United States
(12) Patent Application Publication
(10) Pub. No.: US 2005/0171753 A1
(43) Pub. Date: Aug. 4, 2005

(54) Arrangement and method of estimating and optimizing energy consumption of a system including I/O devices

(76) Inventors: Tajana Simunic Rosing, Sunnyvale, CA (US); Ozgur Celebican, Atlanta, GA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,041

(22) Filed: Jan. 30, 2004

(51) Int. Cl. G06F 17/50

(52) U.S. Cl. 703/18

(57) ABSTRACT

An arrangement and method provides energy consumption estimates of a multiple component electrical system controlled by a processor. The arrangement includes a component model corresponding to each component of the system. Each component model includes an energy consumption value for each one of a plurality of operating modes of its corresponding component. The operation of the system is then simulated on an operating cycle by operating cycle basis. A mode detector determines the operating mode of each system component during each cycle of the simulated operation and an energy consumption evaluator determines energy consumption of each component for each operating cycle. An accumulator then determines a total energy consumption of all of the system components.

### BACKGROUND OF THE INVENTION

Energy consumption is a critical factor in system-level design of embedded portable appliances. Ideally, when designing an embedded system built of commodity components, it would be a desire of the designer to explore a limited number of architectural and peripheral alternatives and test functionality, energy consumption, and performance without the need to build a prototype first. Designers would then endeavor to optimize software both during hardware development and once the prototype is built.

Embedded software optimization requires tools for estimating the impact of program transformations on energy consumption and performance. To date, only performance and energy evaluation of processor and memory is possible.

Recent measurements indicate that as much as 70% of the total system energy is consumed by the input/output (I/O) devices in portable systems. Thus, it would be desirable to be able to estimate performance and the power consumption of peripheral devices such as audio, video, and wireless link devices.

Commercial tools target many functional verification and performance estimation, but provide no support for energy-related cost metrics. Processor energy consumption is generally estimated by instruction-level power analysis. A few prototype tools that estimate the energy consumption of processor core, caches, and main memory have been proposed. One proposed measurement based approach is capable of course grained power estimations of device driver software. Although this system enables accurate code profiling of an existing system, it would be very difficult to use it for both hardware and software architecture exploration. Thus, there is a need in the art, for an arrangement and method that enable fast and accurate energy modeling and optimization of input and output devices typically present in portable systems. More specifically, there is a need for such an arrangement and method enabling simulation of I/O modules on a cycle-accurate basis for obtaining very accurate estimates of both hardware and software energy consumption in typical portable devices. The present invention fulfills that and other needs.

### SUMMARY OF THE INVENTION

According to one embodiment of the invention, an arrangement predicts energy consumption of a multiple component electrical system controlled by a processor. The arrangement comprises a component model corresponding to each component of the system with each component model including an energy consumption value for each one of a plurality of operating modes of its corresponding component. The arrangement further includes a simulator that simulates operation of the system on an operating cycle to operating cycle basis, a mode detector that determines operating mode of each system component during each cycle of the simulated system operation, an energy consumption evaluator that determines energy consumption of each component for each operating cycle responsive to the determined component operating modes, and an accumulator that determines a total energy consumption of all of the system components.

The invention also provides a method of determining energy consumption of a multiple component electrical system controlled by a processor. The method comprises the steps of assigning an energy consumption value for each operating mode of each system component, simulating operation of the system on an operating cycle by operating cycle basis, determining operating mode of each system component during each operating cycle, determining the energy consumption of each system component responsive to the operating modes for each operating cycle based upon the energy consumption values and calculating a totaled energy consumption of the system.

### BRIEF DESCRIPTION OF THE DRAWINGS

The features of the present invention which are believed to be novel are set forth with particularity in the appended claims. The invention, together with further objects and advantages thereof, may best be understood by making reference to the following description taken in conjunction with the accompanying drawings, in the several figures of which like reference characters identify like elements, and wherein:

FIG. 1 is a block diagram of simulator architecture according to one embodiment of the present invention; and

FIG. 2 is a flow chart describing energy consumption estimating and optimization according to an embodiment of the present invention.

### DESCRIPTION OF THE INVENTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined by the appended claims.

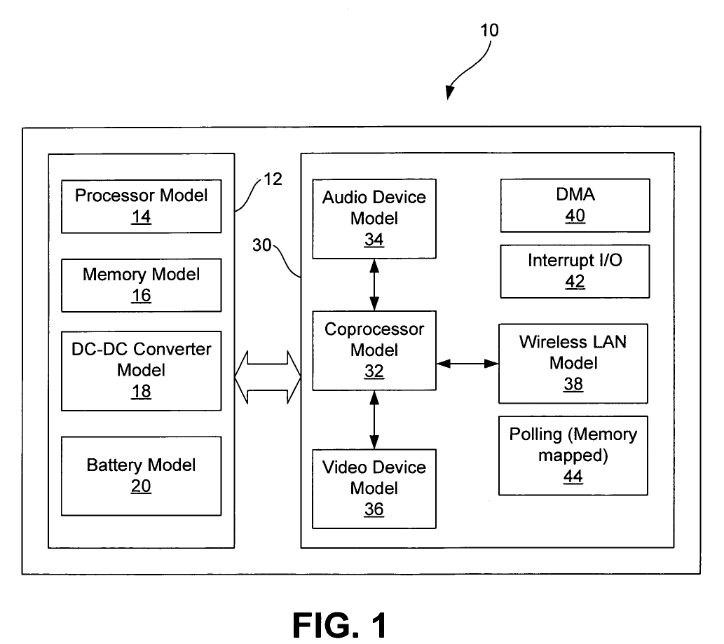

Referring now to FIG. 1, it illustrates a block diagram 10 of a simulator architecture according to one embodiment of the present invention. As will be seen hereinafter, the embodiments of the invention disclosed herein enable cycle-accurate energy consumption simulation and profiling to estimate the performance and the energy consumption of I/O devices, such as audio, video, and wireless large area network (LAN) devices. In FIG. 1, the architecture 12 is known in the art and represents a known simulator. The simulator 12 includes a component model of a processor 14, a memory model 16, a model 18 of a DC-DC converter, and a model 20 of a battery. The simulator 12 calculates the energy consumed by the processor, memory, DC-DC converter and battery during each operating cycle of the processor 14. As will be seen subsequently, the energy consumption calculated by the simulator 12 is added to the energy consumption calculated by the simulator 30 according to this embodiment of the invention.

The simulator 30 includes a coprocessor model 32, input/output (I/O) component models including an audio device model 34, a video device model 36, and a wireless LAN model 38. In addition, the simulator 30 further includes three different types of communication protocol models including a direct memory access (DMA) model 40, an interrupts model 42, and a memory mapped polling model 44.

These communication protocols support communication between the processor 32 and the peripherals 32, 34, and 36 and define various types of audio, video, and communication devices, as may be known in the art. Each I/O component is characterized by different operation modes. Illustrative operation modes are shown, for example, in Table I below.

Modules and parameters affecting power for each module

| | |
|---|---|
| Module | Parameters |
| Coprocessor | Operational modes (active, idle, sleep) |
| | I/O Ports (audio, video, wireless) |
| Audio, Video | Operational modes (active, idle, sleep) |
| Wireless LAN | Operational modes (transmit, receive, idle, |
| | sleep) |
| | Bandwidth |
| | Bit error rate, SNR |

For each mode there is an equivalent energy consumption or capacitance value which may be calculated from the power and performance values given in data sheets provided by the manufacturer of the standard I/O devices. As an example, an I/O controller may have two power modes, active and idle. Supply voltage (V_{dd}) and current (I) are provided on the data sheet for each mode. The equivalent capacitance values may be determined for each mode by the relationship below.

$$C = \frac{I}{{V}_{dd} \times f}$$

where:
C is the equivalent capacitance;
I is the current;
V_{dd} is the supply voltage; and
f is the I/O controller operating frequency.

Using the equivalent capacitance, the energy consumption per cycle for each mode may be calculated from the relationship below.

$$E = \frac{C \times {V}_{dd}^{2}}{N}$$

where:
E is the energy consumption per cycle;
C is the equivalent capacitance;
V_{dd} is the supply voltage; and
N is the ratio of bus frequency to I/O controller frequency.

More simple peripherals, such as audio and video devices, may be modeled as a special memory with peripheral-type access. For example, a video device may be modeled as memory with a DMA-type access. Communication devices, such as wireless LAN devices, may require modeling of conditions outside the embedded system. For instance, the Gilbert model, known in the art, may be used to express bit error rates during simulation.

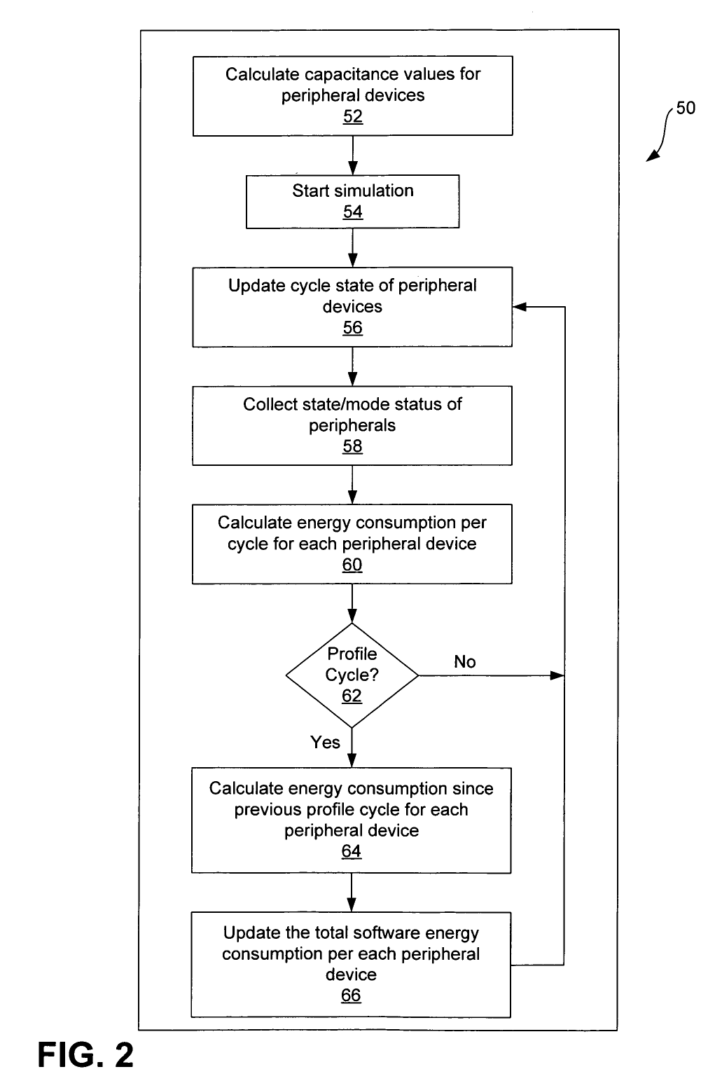

Referring now to FIG. 2, it describes a process according to an embodiment of the present invention by which energy consumption of a plurality of components of an electrical system controlled by a processor maybe estimated and optimized. Initially, the operating modes of the peripheral components are correlated with the operating states of the coprocessor 32. Also, as previously mentioned, an equivalent capacitance value is determined and assigned to each component model for each of its operating modes. Energy consumption is then calculated based on the equivalent capacitance value, voltage, the cycle time and the number of cycles of access of the device.

The operating states of the processor, as may be seen in Table I, may include an active state, an idle state, and a sleep state. When the processor is in an active state, the peripherals and memory are in a low-power state, as for example, an idle or sleep state. When the processor needs a memory access due to a cache miss, it is in idle state until cache is refilled. Data transfer to one of the peripherals includes a combination of active and idle cycles - active when processor is processing data and copying it onto the peripheral bus, idle when it is waiting for a response from the peripheral. Simulation models account for the total capacitance switched in the interconnect and pins per each data transfer.

Referring now more particularly to FIG. 2, the process 50 there shown initiates with an activity block 52 wherein an equivalent capacitance value is determined and assigned to each component model for each of its operating modes. Energy consumption is calculated based on the equivalent capacitance value, voltage, the cycle time and the number of cycles of access of the device. Once activity block 52 is completed, the process advances to activity block 54 wherein simulated operating cycle by operating cycle operation of the simulation model 30 is started. Next, in activity block 56, the correlation between processor state and peripheral operating modes are updated.

Once the correlation is completed between the processor operating states and the peripheral operating modes is completed, the process advances to activity block 58. Here, the processor operating state and corresponding peripheral operating modes are determined. Once the processor operating state and peripheral operating modes are determined in accordance with activity block 58, the process advances to activity block 60 wherein the energy consumption of each peripheral device for the current operating cycle is determined. Following activity block 60, the process advances to decision block 62 wherein it is determined if there is to be software profiling. If there is to be no current software profiling, the process returns to activity block 56 for implementing the process during the next processor operating cycle. However, if software profiling is to be performed, as will be seen hereinafter, according to this embodiment, it is possible to profile software routines according to both total and per component energy consumptions. This ability is very helpful for energy optimization of device drivers. As mentioned earlier, a large fraction of system energy is often spent due to inefficient peripheral accesses, which include both the selection of peripheral hardware architecture and the optimization of device drivers.

In activity block 64 which is implemented upon an affirmative decision to perform software profiling, the process calculates the energy consumption since the last profile cycle for each peripheral device. The profile cycle may be every operating cycle, for example, or less frequently. Hence, for each peripheral device, the profiler includes a calculator that calculates energy consumption of selected ones or all of the system components from the end of a last profile cycle to the end of a current profile cycle.

Following activity block 64, the process then proceeds to activity block 66 wherein the total software energy consumption for each peripheral device is updated. The process returns upon completion of activity block 66.

Once the simulation is completed, the total energy consumption of the peripheral devices may be calculated. To this, the power consumption of the simulator 12 may be added to provide the total energy consumption of the entire system 10.

To illustrate the advantages in the aforementioned methodology, a simulation and profiling according to this embodiment revealed that the method used to access audio was an energy bottleneck. The original implementation used polling to check the status of data first in first out (FIFO) registers inside the I/O device prior to the data transfer. To save energy, the access method was redesigned so that the device driver used interrupts to communicate the status of the FIFO registers. Next, the method according to this embodiment highlighted a problem with data transfer. As a result, the device driver was redesigned to use direct memory access. Hence, by virtue of the present invention, educated guesses of energy consumption and confirmation thereof with a hardware prototype is avoided. By virtue of the present invention, many different hardware and software configurations may be profiled and optimized in a manner of a few hours.

By virtue of the various embodiments of the present invention, complete system-level and component energy consumption estimates of input and output devices, such as audio, video, or wireless LAN devices are rendered possible. The estimation is tightly coupled with the power analysis of systems that include a processor, memory, DC-DC converter, and battery. In this manner, both performance and the power consumption of portable systems may be fully optimized. In addition, the present invention provides an ability to quickly explore multiple architectural alternatives. Still further, the invention enables software optimization both during and after architectural exploration.

The various embodiments of the invention disclosed herein may be implemented as a sequence of computer-implemented steps or program modules running on a computer system and/or has interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, and firmware, and special-purpose digital logic, or any combination thereof without deviating from the spirit and scope of the present invention. Hence, while particular embodiments of the present invention have been shown and described herein, modifications may be made, and it is therefore intended to cover such changes and modifications which fall within the true spirit and scope of the invention.

1. An arrangement that predicts energy consumption of a multiple component electrical system controlled by a processor, comprising:
a component model corresponding to each component of the system, each component model including an energy consumption value for each one of a plurality of operating modes of its corresponding component;
a simulator that simulates operation of the system on an operating cycle to operating cycle basis;
a mode detector that determines operating mode of each system component during each cycle of the simulated system operation;
an energy consumption evaluator that determines energy consumption of each component for each operating cycle responsive to the determined component operating mode; and
an accumulator that determines a total energy consumption of all the system components.

2. The arrangement of claim 1 further comprising a state detector that determines operating state of the processor during each cycle of the simulated system operation, and a correlator that correlates the processor operating states with the operating modes of each system component, wherein the energy consumption evaluator determines energy consumption of each component for each operating cycle responsive to the determined processor operating state.

3. The arrangement of claim 1 further comprising a profiler that provides a software profile of the energy consumption of each system component.

4. The arrangement of claim 3 wherein the profiler includes a calculator that calculates energy consumption of selected system components from the end of a last profile cycle to the end of a current profile cycle.

5. The arrangement of claim 1 wherein at least one component model corresponds to an I/O device.

6. The arrangement of claim 1 wherein at least one component model corresponds to one of an audio device, a video device, and a wireless LAN device.

7. The arrangement of claim 1 wherein the component models include component modules corresponding to a plurality of communication protocols.

8. The arrangement of claim 7 wherein the communication protocols include at least one of a direct memory access protocol, an interrupts protocol, and a memory mapped polling protocol.

9. An arrangement that predicts energy consumption of a multiple component electrical system controlled by a processor, comprising:
a plurality of component models, each component model corresponding to a component of the system, each component model including an energy consumption value for each one of a plurality of operating modes of its corresponding component;
a simulator that simulates operation of the system on an operating cycle to operating cycle basis;
a state detector that determines operating state of the processor during each cycle of the simulated system operation;
a correlator that correlates the processor operating states with the operating modes of each system component;
an energy consumption evaluator that determines energy consumption of each component for each operating cycle responsive to the determined processor operating state; and
an accumulator that determines a total energy consumption of all of the system components.

10. The arrangement of claim 9 further comprising a profiler that provides a software profile of the energy consumption of each system component.

11. The arrangement of claim 10 wherein the profiler includes a calculator that calculates energy consumption of selected system components from the end of a last profile cycle to the end of a current profile cycle.

12. The arrangement of claim 9 wherein at least one component model corresponds to an I/O device.

13. The arrangement of claim 9 wherein at least one component model corresponds to one of an audio device, a video device, and a wireless LAN device.

14. The arrangement of claim 9 wherein the component models include component modules corresponding to a plurality of communication protocols.

15. The arrangement of claim 14 wherein the communication protocols include at least one of a direct memory access protocol, an interrupts protocol, and a memory mapped polling protocol.

16. A method of determining energy consumption of a multiple component electrical system controlled by a processor, comprising:
assigning an energy consumption value for each operating mode of each system component;
simulating operation of the system on an operating cycle by operating cycle basis;
determining operating mode of each system component during each operating cycle;
responsive to the operating modes, determining the energy consumption of each system component for each operating cycle based upon the energy consumption values; and
calculating a total energy consumption of the system.

17. The method of claim 16 wherein the first determining step includes correlating processor operating states with system component operating modes and determining processor operating state during each operating cycle.

18. The method of claim 16 including the further step of profiling energy consumption of each system component on an operating cycle by operating cycle basis.

19. The method of claim 16 wherein the profiling step includes calculating the power consumed by each system component from the end of a last operating cycle to the end of a current operating cycle.

20. An arrangement for determining energy consumption of a multiple component electrical system controlled by processing means, comprising:
means for assigning an energy consumption value for each operating mode of each system component;
simulation means for simulating operation of the system on an operating cycle by operating cycle basis;
means for determining operating mode of each system component during each operating cycle;
means responsive to the operating modes for determining the energy consumption of each system component for each operating cycle based upon the energy consumption values; and
calculating means for calculating a total energy consumption of the system.
